(19) United States
(12) Patent Application Publication
(10) Pub. No.: US 2018/0345237 A1
(43) Pub. Date: Dec. 6, 2018

(54) STIRRER SET AND STIRRING DEVICE

(71) Applicant: Taiwan Advanced Nanotech Inc., Taoyuan City, Taoyuan County (TW)

(72) Inventors: Chien-Hsing CHIEN, Taoyuan City (TW); Ching-Ju HUANG, Taoyuan City (TW); Kuan-Ming LU, Taoyuan City (TW); Su-Chin SUN, Taoyuan City (TW)

(73) Assignee: Taiwan Advanced Nanotech Inc., Taoyuan City, Taoyuan County (TW)

(21) Appl. No.: 15/546,265

(22) PCT Filed: Feb. 9, 2015
(86) PCT No.: PCT/CN2015/072540

§ 371 Date: Jul. 25, 2017

(51) Int. Cl. B01F 15/00; B01F 13/10; B01F 7/16; B01F 13/08

(52) U.S. Cl. CPC B01F 15/00454; B01F 13/1022; F16H 7/06; B01F 13/08; B01F 7/161

(57) ABSTRACT

The present invention provides a stirrer set, comprising: a fitting tube having an opening portion and a hollow rotating shaft fitted into the opening portion, the hollow rotating shaft having an external wall which is annularly recessed to form at least one annular groove. The present invention also provides a stirring device, wherein a drive element comprising a power transmission element, such as a belt, may be rotatably driven to cause, via the power transmission element, the stirrer set to rotate for performing a stirring function. As such, the stirring device provides higher design flexibility when dealing with high-flux samples, and the element replacement rates can be significantly reduced. Thus, the costs related to manufacturing, repair, maintenance and other processes can be reduced in an effective manner.

### BACKGROUND

### Technical Field

The present invention relates to a stirrer set and a stirring device; more particularly, the present invention provides a stirrer set having annular grooves, and a stirring device wherein the stirrer set is driven by a power transmission element (such as a belt) for performing a stirring function.

### Description of Related Art

There are many types of stirrers that can be found on the market, such as vibrating stirrers or magnetic stirrers. Stirrers can be used to stir solutions and reagents in order to accelerate the dissolution of a solute or prevent coagulation.

A vibrating stirrer is a device manufactured by including a piezoelectric ceramic transducer that is able to convert a voltage to mechanical vibrations. This device is designed for carrying out steps of a biological or chemical analysis (including steps such as solidification, wash or interaction), and generally comprises a vibrating unit for which vibration frequencies can be controlled, a transmission portion driven and vibrated by the vibrating unit, and a stirring unit connected to and driven by the transmission portion, wherein one or more stirring rods are provided in the stirring unit. Typically, the vibrating unit is caused to generate vibrations at specific frequencies, and the stirring unit is driven to perform the stirring via the transmission portion. By accurately controlling frequencies, amplitudes and durations of the vibrations, a vibrating stirrer can perform stirring functions or help increase reaction rates. However, problems with a vibrating stirrer still exist: air may enter into samples during vibrations and result in contaminations, or cross-sectional areas of its elements are not compatible with other devices.

As for a magnetic stirrer, it is a laboratory device designed for stirring liquids with rapidly rotating magnetic stir bars. The device is able to stir solutions as rotating magnets within cause stir bars to rotate. These stir bars function well in a glass beaker in that a glass beaker allows most chemical reactions to occur and is made of a material that does not block magnetic fields. Nevertheless, due to dimension limits of a stir bar (which comes in various models and sizes), a magnetic stirrer stirs well only for liquids used in relatively small experiments (i.e. volume of a solution less than 4 liters). For stirring high-volume solutions and viscous liquids, by contrast, a magnetic stirrer is far less suitable than a conventional mechanical stirrer. In addition, a magnetic stirrer is often used for stirring solutions during biological or chemical reactions in an open system. Once a magnetic stir bar of the stirrer is contaminated, contamination to the reaction solutions is very likely to ensue.

As for an automated nucleic acid extraction platform, the technical concept behind its design is similar to that of a magnetic stirrer. The device uses primarily the force of attraction between ferrite beads and a magnet to perform the stirring function. A permanent bar magnet or an electromagnet is first inserted into a stirrer set, and the ferrite beads are then fixed onto to the external walls of a stirrer set disposed on an end of the magnet, wherein the stirrer set is used as a protection layer for the magnet when reagents are being mixed together and the ferrite beads are rotating. As soon as the device is turned on, the stirrer set will oscillate vertically to be able to mix samples. As such, more space should be reserved inside the container to achieve better mixing efficiency. But if too many samples are put and mixed within such a limited space, cross-contamination is still unavoidable.

In view of the above, the applicant's research team has developed a stirring device and a gear set, wherein a stirrer set is driven by the gear set to perform a stirring function, so that not only the solution flux per unit area is maximized, but the risk of cross-contamination is reduced effectively.

However, due to the limitations of gears resulting from the mechanical structures, a new type of stirrer is still needed.

### SUMMARY

An object of the present invention is to provide a stirrer set with a simple structure that helps reduce costs related to manufacturing, repair, maintenance and other processes effectively.

The stirrer set comprises:

a fitting tube having an opening portion; and

a hollow rotating shaft fitted to the opening portion and having an external wall which is annularly recessed to form at least one annular groove, wherein the annular groove is rotatably driven to cause the hollow rotating shift and the fitting tube to rotate for performing a stirring function.

In one embodiment, the fitting tube may have an opening portion at one end and a closed portion at the other end.

In an alternative embodiment, the stirrer set may have a plurality of annular grooves.

In a further alternative embodiment, the annular groove is spiral-shaped along the axial direction of the hollow rotating shaft.

The other object of the present invention is to provide a stirring device making use of the stirrer set, wherein the design adopts a pulley-like system to overcome limitations of gears caused by their mechanical structure in terms of pattern arrangement, arrangement design and friction loss. As such, the stirring device will provide higher design flexibility when dealing with high-flux samples, and the element replacement rates can be significantly reduced.

The stirring device comprises:

a stirrer set comprising a fitting tube and a hollow rotating shaft, wherein the fitting tube has an opening portion, and the hollow rotating shaft is fitted into the opening portion and has an external wall which is annularly recessed to form at least one annular groove; and

a drive element comprising a drive shaft and a power transmission element which is fitted respectively onto the drive shaft and the annular groove of the hollow rotating shaft,

wherein the drive shaft provides a driving force to the annular groove via the power transmission element, so as to cause the hollow rotating shaft and the fitting tube to rotate for performing a stirring function.

In one embodiment, the fitting tube may have an opening portion at one end and a closed portion at the other end.

In an alternative embodiment, the stirrer set may comprise a plurality of annular grooves.

In a further alternative embodiment, the annular groove is spiral-shaped along the axial direction of the hollow rotating shaft.

In one embodiment, the stirring device may further comprise a bar magnet. In one embodiment, the bar magnet may be inserted through the hollow rotating shaft and the opening portion of the fitting tube to produce magnet effects.

In one embodiment, the drive element may be driven rotatably by a motor, but is not limited to the foregoing.

In one embodiment, the power transmission element is loop-shaped.

In one embodiment, the power transmission element may be a chain or a belt, but is not limited to the foregoing.

In one embodiment, when the stirring device comprises a plurality of stirrer sets, they are arranged in an array pattern and separated by spacings. This array pattern may be a symmetrical or asymmetrical geometric shape, such as a square, a rectangle, a triangle, a pentagon or a hexagon.

In one embodiment, a drive element may comprise a plurality of drive shafts. In one embodiment, a drive element may, when comprising a plurality of drive shafts, comprise a plurality of power transmission elements further fitted between the plurality of driving shafts.

In one embodiment, the above stirring device may further comprise a support stand comprising a support frame and a base. In one embodiment, the stirrer set may be received in the support frame and the drive element may be installed to the base.

The stirrer set and the stirring device of the present invention have relatively simple structures. As such, costs related to manufacturing, repair, maintenance and other processes can be reduced in an effective manner. Furthermore, the design of the present invention can help reduce friction loss effectively so that the element replacement rates can be significantly reduced. In addition, in view of the design of the present invention, more stirrer sets can be arranged in any patterns by simply changing the length of a belt, thereby increasing the flexibility for increasing or reducing an operating volume according to the user's needs.

### BRIEF DESCRIPTION OF THE DRAWINGS

FIG. 1 schematically shows the major components of a stirrer set according to one embodiment of the present invention, wherein Figure A is an exploded view drawing and Figure B is a fitted assembly drawing.

FIG. 2 schematically shows a plurality of stirrer sets arranged in an array according to one embodiment of the present invention.

FIG. 3 schematically shows a stirring device according to one embodiment of the present invention.

FIG. 4 schematically shows a stirring device in use according to an alternative embodiment of the present invention.

FIG. 5 schematically shows part of the components of a stirring device according to yet another embodiment of the present invention.

### DETAILED DESCRIPTION

Details of one or more embodiments of the present invention will be provided in the accompanying drawings and the description below. The features, purposes and strengths of the present invention may be easily understood based on the description, accompanying drawings as well as claims. In order to illustrate these features and strengths in a clearer and more comprehensible manner, several exemplary embodiments are detailed as below with reference to the accompanying drawings.

While the strengths and features of the present invention may be better understood through detailed descriptions of the exemplary embodiments and the accompanying drawings, the invention may also be achieved in various forms and should not be construed as limited to the embodiments mentioned herein. However, to a person having ordinary skill in the art, the scope of the invention will become more thorough and comprehensible with these exemplary embodiments, yet the invention is defined by the appended claims. Furthermore, dimensions and relative dimensions of the components and elements are exaggerated in the drawings for clarity of illustration. The same constituent elements in the drawings are denoted by the same reference numerals throughout the specification. In addition, the term “and/or” refers to any or all combinations of one or more related items listed herein.

Unless otherwise defined, all terms used herein including technical and scientific terms are understood in the same way a person skilled in the art understands them. It may be further understood that such terms as defined in generally used dictionaries should be construed to have the same meanings as those in the contexts of related art, and unless clearly defined herein, they should not be construed in an excessively ideal or formal meaning.

Unless otherwise stated herein, the determiners with a singular form including “a,” “at least one” and “the” used herein may refer to a plurality of objects.

Exemplary embodiments of the present invention will be described below in detail with reference to the accompanying drawings. However, these embodiments may be carried out in various forms and should not be construed as limiting the scope of the claims. It is through these embodiments that the disclosure in the present invention is clearly and completely illustrated, and that a person skilled in the art will be able to understand the scope of the invention.

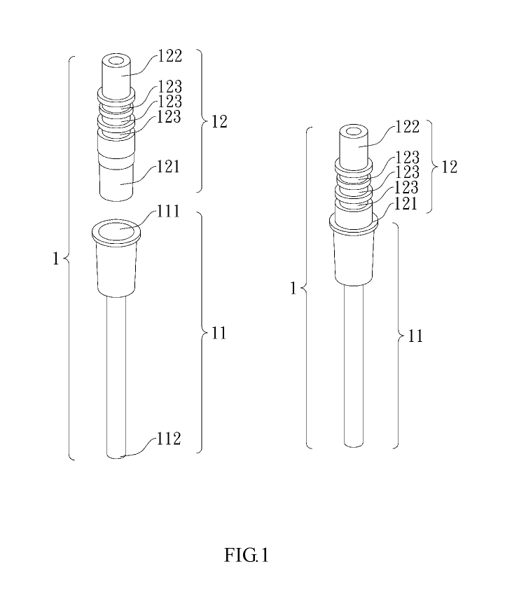

FIG. 1 schematically shows the major components of a stirrer set according to one embodiment of the present invention, wherein Figure A is an exploded view drawing and Figure B is a fitted assembly drawing. The stirrer set 1 comprises:

a fitting tube 11, having an opening portion 111 at one end is and a closed portion 112 at the other end; and

a hollow rotating shaft 12, wherein a connecting end 121 extends from the hollow rotating shaft 12 and is fitted and installed into the opening portion 111, and an external wall 122 of the hollow rotating shaft 12 is annularly recessed to form a plurality of annular grooves 123.

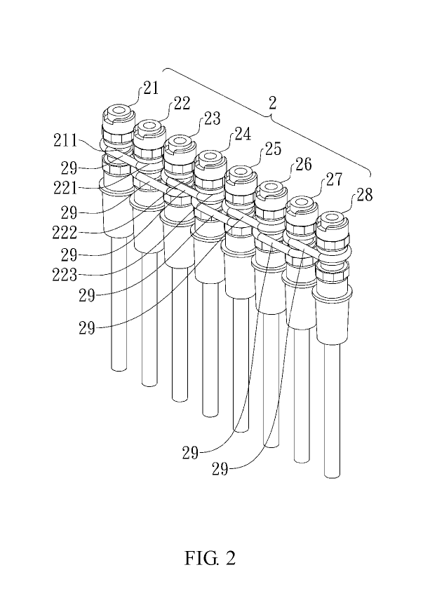

FIG. 2 further shows a plurality of stirrer sets, including a stirrer set 21, a stirrer set 22, a stirrer set 23, a stirrer set 24, a stirrer set 25, a stirrer set 26, a stirrer set 27, and a stirrer set 28; these stirrer sets are arranged in a pattern of a straight array 2. FIG. 2 also shows a loop-shaped power transmission element 29, or a belt in the present embodiment (a person skilled in the art can use a toothed or non-toothed belt according to one's needs). One end of the belt is fitted onto adjacent stirrer sets in an alternately up and down manner, and the other end is fitted onto a drive element (see descriptions below) that provides a driving force for rotation. To illustrate such a configuration, the belt is fitted into upper annular grooves 211 and 221 of the adjacent stirrer sets 21 and 22, then into lower annular grooves 222 and 232 of the stirrer sets 22 and 23, and so on. This alternate arrangement creates a tension on the belt for it to cling on the multiple stirrer sets without becoming loose. When in use, the driving force for rotation provided by the driving element is transmitted via the belt towards the stirrer sets 22, 23, 24, 25, 26, 27 and 28, and drives the hollow rotating shafts and the fitting tubes to rotate and thus perform a stirring function. The loop-shaped power transmission element 29 of the present invention may include, but not limited to, a chain or a belt; in fact, it may be any object that can be fitted into an annular groove to provide a driving force for rotation, wherein the annular groove is spiral-shaped along the axial direction of the hollow rotating shaft 12.

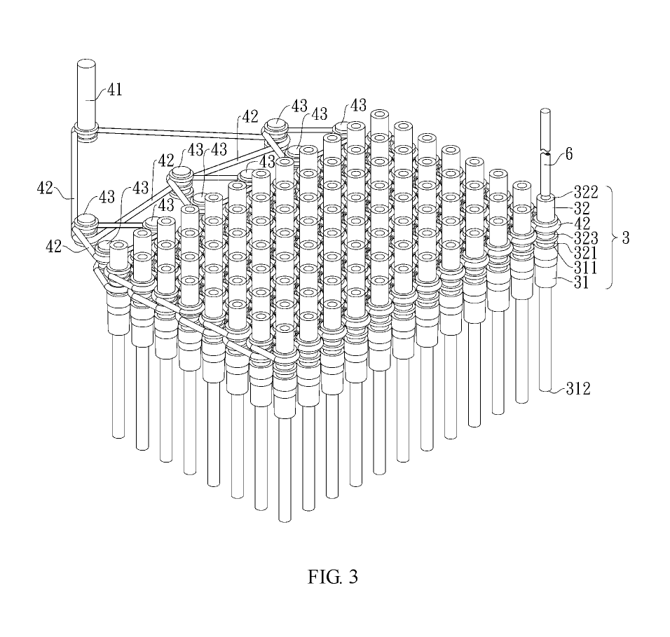

FIG. 3 schematically shows a stirring device according to one embodiment of the present invention. The stirring device comprises:

a plurality of stirrer sets 3, arranged adjacent to one another in a square array pattern, each of the stirrer sets comprising a fitting tube 31 and a hollow rotating shaft 32, wherein the fitting tube 31 has an opening portion 311 at one end and a closed portion 312 at the other end, a connecting end 321 extends from the hollow rotating shaft 32 and is fitted and installed into the opening portion 311 of the fitting tube 31, and an external wall 322 of the hollow rotating shaft 32 is annularly recessed to form a plurality of annular grooves 323; and

a drive element, comprising a drive shaft 41, a plurality of loop-shaped power transmission elements 42 and a plurality of auxiliary drive shafts 43, the power transmission elements 42 in the illustrated embodiment being belts that are fitted onto each of the drive shafts 41, each of the auxiliary drive shafts 43 and each of the stirrer sets 3, the power transmission elements 42 being fitted, in an alternate up and down manner, into the annular grooves 323 of the stirrer sets 3 adjacent to one another. The drive shaft 41 of the drive element is driven using a known technique, and in this embodiment, the drive shaft 41 of the drive element is driven by a motor (not shown in FIG. 3) to rotate.

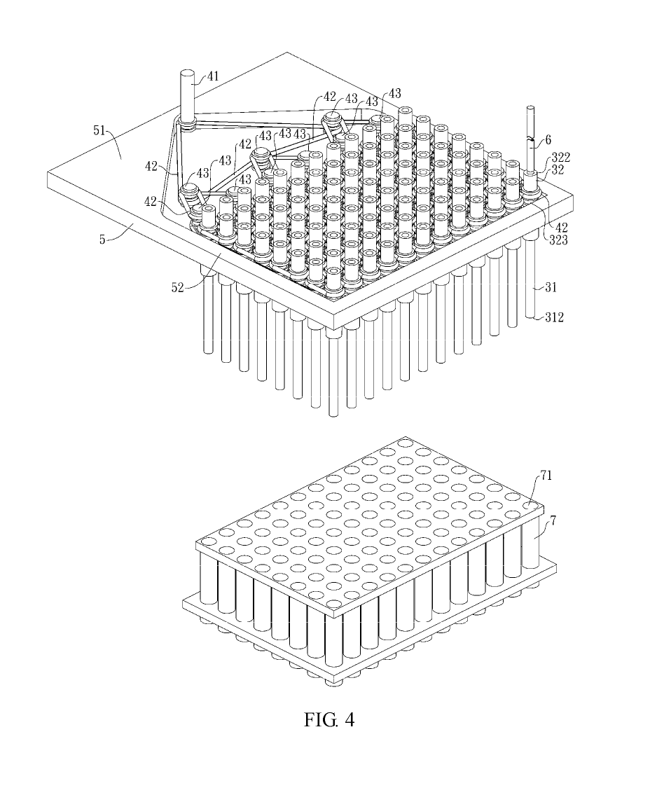

FIG. 4 schematically shows an alternative embodiment in which the stirring device may be installed on a support stand 5 comprising a base 51 and a support frame 52. The plurality of stirrer sets 3 are received in the support frame 52, and the drive shaft 41 of the drive element as well as a plurality of auxiliary drive shafts 43 are installed to the base 51. In order to produce magnetic effects, the stirring device may include one or a plurality of bar magnets 6 as well as a sample cell 7. The sample cell 7 includes a plurality of cells 71 (such as 96 cells), and descriptions of usage thereof are given as below.

As shown in FIGS. 3 and 4, during a normal rotating and stirring operation, when the drive shaft 41 of the drive element is driven by a motor and starts to rotate, the power transmission element 42 (such as a belt) fitted onto the drive shaft 41 will also be driven and start to rotate. The other end of the power transmission element 42 is fitted in an alternate manner onto a plurality of auxiliary shafts 43. As other power transmission elements 42 fitted between the plurality of auxiliary drive shafts 43 and the annular grooves 323 of the hollow rotating shaft 32 are driven by the plurality of auxiliary shafts 43 and start to rotate, a driving force for rotation will be transmitted via the power transmission elements 42 towards the hollow rotating shafts 32. Consequently, the hollow rotating shafts 32 as well as the fitting tubes 31 connected thereto will also be driven and start to rotate, and the rotating and stirring function is then being performed.

In an alternative embodiment, in order to produce magnetic effects, the stirring device may include one or more bar magnets 6. If the stirring device is required to exhibit magnetic properties, the bar magnet 6 may be inserted through the hollow rotating shaft 32, the connecting end 321 and the opening portion 311 of the fitting tube 31 and enter into the fitting tube 31. By doing so, the fitting tube 31 will exhibit magnetic properties to attract magnetic beads (not shown in FIGS. 3 and 4) in each of the cells 71 of the sample cell 7.

In an alternative embodiment, the stirrer set 3 is detachable. A fitting tube 31 has an opening portion 311 at one end and a closed portion 312 at the other end; moreover, the opening portion 311 of the fitting tube 31 may allow itself to be inserted by a connecting end 321 of a hollow rotating shaft 32 to form a combination. Through a special design of the connecting end 321, consumables below the connecting end 321 (the fitting tube 31) may be replaced rapidly and automatically to ensure that replacements are well-aligned. In addition, when the stirring device is being operated, consumables may automatically be inserted into or taken out from the connecting ends 321; thus, conventional operations that rely on a similar stirring device can be simplified and sample contamination reduced.

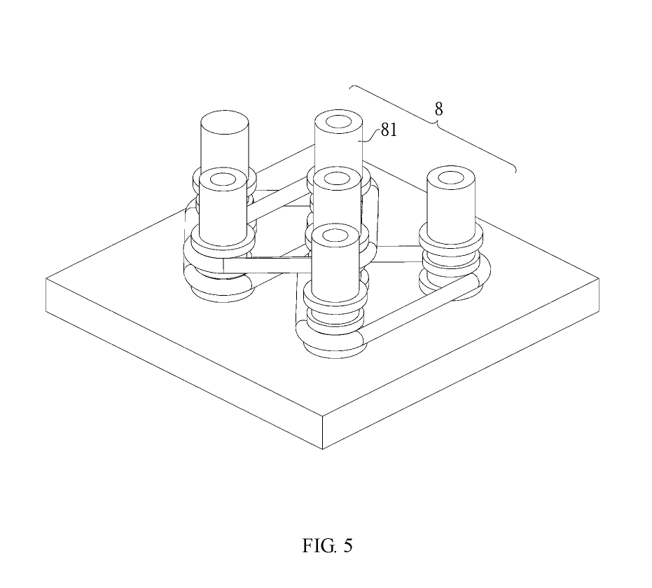

Furthermore, FIG. 5 schematically shows part of the components of a stirring device according to an alternative embodiment of the present invention. As shown in FIG. 5, stirrer sets 81 of a stirring device 8 are arranged in an irregular array pattern that indicates one major characteristic of the present invention: the adoption of a structural design which is similar to the design of a belt-driven pulley system. This design of the present invention may overcome the limitations in pattern arrangement where gear teeth are required to mesh tightly with each other. The invention may also provide a stirring device that is flexible enough for the user to make different designs with various geometrical array patterns in order to perform a stirring function based on one's needs.

As a sample volume to be stirred increases, a diameter of a container should increase accordingly. If every stirring unit adopts any of the existent gear-driven stirring techniques, one major obstacle in terms of gear design will occur relating to distances between gears. Technically, when it comes to the design of a stirring device, it is extremely difficult to enlarge gears or mesh more gears together. When faced with a request to stir high-volume samples, a gear-based stirring device can hardly cater to such a demand through prompt structural adjustments. The present invention, by contrast, allows an arrangement with more stirrer sets in any pattern one would prefer through a simple change to the belt length. As possibilities of pattern arrangements increase, flexibility of adjustment will be greater for the user to increase or reduce an operating volume according to one's needs.

On the other hand, while for all existent gear-driven stirring techniques, gears are likely to be worn out due to pivoting friction, the design of the present invention is effective in reducing friction loss as well as element replacement rates significantly. Furthermore, compared to gear-driven techniques, the stirrer set and the stirring device of the present invention have simpler structures that can help reduce costs related to manufacturing, repair, maintenance and other processes.

The features disclosed in the present invention may be replaced by those that are identical, equivalent or fulfilling similar purposes. In this regard, unless otherwise described, the features disclosed in the present invention represent one embodiment among a series of equivalent or similar features.

In addition, a person skilled in the art can, based on the basic features of the present invention and without departing from its spirit and scope, easily make proper alterations and modifications according to various usages or purposes. In this light, other embodiments are also covered by the claims of the invention.

1-16. (canceled)

17. A stirrer set, comprising:
a fitting tube having an opening portion;
a hollow rotating shaft connected to the opening portion and having an external wall which is annularly recessed to form at least one annular groove, wherein the annular groove is rotatably driven to cause the hollow rotating shaft and the fitting tube to rotate for performing a stirring function; and
a bar magnet inserted through the hollow rotating shaft and the opening portion of the fitting tube.

18. The stirrer set of claim 17, wherein the fitting tube has the opening portion at one end and a closed portion at the other end.

19. The stirrer set of claim 17, comprising a plurality of annular grooves.

20. The stirrer set of claim 17, wherein the annular groove is spiral-shaped along an axial direction of the hollow rotating shaft.

21. A stirring device, comprising:
a stirrer set comprising a fitting tube, a hollow rotating shaft and a bar magnet, wherein the fitting tube has an opening portion, the hollow rotating shaft is connected to the opening portion and has an external wall which is annularly recessed to form at least one annular groove, and the bar magnet is inserted through the hollow rotating shaft and the opening portion of the fitting tube; and
a drive element comprising a drive shaft and a power transmission element which is fitted respectively onto the drive shaft and the annular groove of the hollow rotating shaft,
wherein the drive shaft provides a driving force to the annular groove via the power transmission element, so as to cause the hollow rotating shaft and the fitting tube to rotate for performing a stirring function.

22. The stirring device of claim 21, wherein the fitting tube has the opening portion at one end and a closed portion at the other end.

23. The stirring device of claim 21, comprising a plurality of annular grooves.

24. The stirrer set of claim 21, wherein the annular groove is spiral-shaped along the axial direction of the hollow rotating shaft.

25. The stirring device of claim 21, wherein the drive element is rotatably driven by a motor.

26. The stirring device of claim 21, wherein the power transmission element is loop-shaped.

27. The stirring device of claim 21, wherein the power transmission element is a chain or a belt.

28. The stirring device of claim 21, wherein when the stirring device comprises a plurality of stirrer sets, the stirrer sets are arranged in an array pattern.

29. The stirring device of claim 21, wherein the drive element comprises a plurality of drive shafts.

30. The stirring device of claim 29, wherein the drive element comprises a plurality of power transmission elements further fitted between a plurality of drive shafts.

31. The stirring device of claim 21, further comprising a support stand which comprises a support frame and a base.

32. The stirring device of claim 31, wherein the stirrer set is received in the support frame and the drive element is installed to the base.

33. The stirring device of claim 28, wherein the drive element comprises a plurality of drive shafts.
